(19) United States
(12) Patent Application Publication
(10) Pub. No.: US 2006/0034096 A1
(43) Pub. Date: Feb. 16, 2006

(54) Spinning fiber optic novelty device and its associated method of manufacture

(76) Inventors: Mark Chernick, Woodinville, WA (US); Webb T. Nelson, Woodinville, WA (US)

Correspondence Address: LAMORTE & ASSOCIATES P.C., P.O. BOX 434, YARDLEY, PA, 19067, US

(21) Appl. No.: 10/916,132

(22) Filed: Aug. 12, 2004

(51) Int. Cl. G02B 6/00

(52) U.S. Cl. 362/551

(57) ABSTRACT

An illumination device that produces a spinning pattern of light. The illumination device utilizes a hub. At least one light source is provided that is supported by the hub. One or more fiber optic bundles are provided that extend from the hub at points eccentric to the axis of rotation for the hub. Each fiber optic bundle has a first end that receives light from the light source and a second end that terminates a predetermined distance from the hub. When the hub rotates about its axis of rotation, the fiber optic strands in the fiber optic bundle bend away from the axis of rotation due to centrifugal force. Light propagates through the various fiber optic strands as they bend, thereby creating a spinning circular pattern of light.

### BACKGROUND OF THE INVENTION

1. Field of the Invention

The present invention relates to illuminated novelty devices that are used to produce observable patterns of light during low light conditions. More particularly, the present invention relates to such novelty devices where the observed pattern of light is produced from an array of spinning light sources.

2. Prior Art Statement

In the prior art, there are many different types of illuminated novelty devices that produce an observable pattern of light. Such devices are not used for the purposes of illumination, like a flashlight. Rather, such novelty devices are merely used to produce an interesting pattern of light that can be observed during low light conditions. Such novelty devices are commonly sold or distributed at events that are frequented by children and where there are low light conditions. Examples of such events include children's concerts, circuses, amusement parks at night, fireworks displays and the like.

There is a great variety in the types of illuminated novelty devices that exist. Some illuminated novelty devices use chemical luminescent light sources, where the observed light is created from a chemical reaction. Such chemical luminescent devices, however, cannot be selectively turned on and off once the chemical reaction has started. Additionally, after a few hours, the chemical reaction ends and the novelty device is incapable of producing light. Furthermore, most chemical compositions used to produce light are toxic. Accordingly, the use of chemical luminescent novelty devices is inappropriate for many young children who may bite or teethe such a device.

Other types of illuminated novelty devices use batteries to provide power to either incandescent bulbs or light emitting diodes (LEDs). Often, to increase the interest of the pattern of light produced by the device, motors are used to move the electric light sources when they are illuminated. One popular type of illuminated novelty device is a device where multiple electric light sources are positioned at the tip of flexible arms. The flexible arms are attached to a hub that is supported by a handle. In the handle is a motor that spins the hub when activated. As such, when a user activates the motor, the hub spins and the lights at the ends of the arms illuminate. The result is a circular pattern of light that is interesting to observe especially in low light conditions.

One problem associated with spinning electric novelty devices is one of safety. As the arms of a spinning novelty light rotate, they gather momentum. Since the light sources of such spinning electric novelty devices are positioned out along the spinning arms, the spinning arms do have a significant mass. Consequently, if a small child using the spinning electric novelty light inadvertently brings that device close to his/her face as it is spinning, a painful injury can occur to the eye, nose or mouth.

A need therefore exists for a spinning novelty device that produces light along extended arms, yet provides arms that have very little mass. In this manner, any inadvertent contact with the spinning arms is unlikely to cause injury. This need is met by the present invention as described and claimed below.

### SUMMARY OF THE INVENTION

The present invention is an illumination device that produces a spinning pattern of light. The illumination device utilizes a hub or similar surface that has an axis of rotation about which it can spin. At least one light source is provided that is supported by the hub. One or more fiber optic bundles are provided that extend from the hub at points eccentric to the axis of rotation for the hub. Each fiber optic bundle has a first end that receives light from the light source and a second end that terminates a predetermined distance from the hub. When the hub rotates about its axis of rotation, the fiber optic strands in the fiber optic bundle bend away from the axis of rotation due to centrifugal force. Light propagates through the various fiber optic strands as they bend, thereby creating a spinning circular pattern of light. Since the spinning strands of fiber optic strands are flexible and have a very low mass, they are unlikely to cause an impact injury.

The light propagating through the fiber optic strands can be controlled so that the circular pattern of light produced by the spinning fiber optic strands can follow predetermined pattern designs and color schemes.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a partially fragmented perspective view of an exemplary embodiment of the present invention spinning illumination device;

FIG. 2 is a schematic of the electronic components contained within the hub section of the embodiment of the present invention shown in FIG. 1;

FIG. 3 is a perspective view of the hub section of the present invention, shown while it spins;

FIG. 4 is a second exemplary embodiment of the present invention; and

FIG. 5 is a third exemplary embodiment of the present invention.

### DETAILED DESCRIPTION OF THE DRAWINGS

Although the present invention spinning illumination device can be configured as part of a larger assembly, such as a toy, a novelty paperweight or the like, the present invention spinning illumination device is particularly well suited as an independent novelty device. Accordingly, the initial embodiment of the present invention is shown as an independent hand-held unit in order to set forth the best mode contemplated for the invention. However, the shown embodiment should not be considered a limitation to the application of the present invention spinning illumination device to larger assemblies.

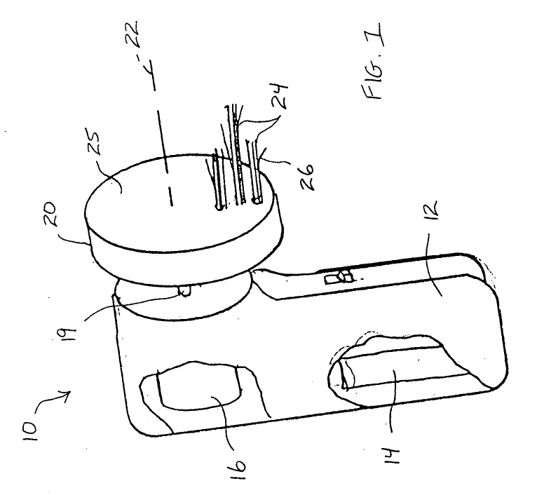

Referring to FIG. 1, a spinning illumination device 10 is shown. The spinning illumination device 10 has a handle section 12. Within the handle section 12 are batteries 14, a motor 16 and an on/off switch 18 that govern the operation of the motor 16. The motor 16 has a drive shaft 19 that extends out of the handle section 12. The drive shaft 19 is rotated by the motor 16 when the motor 16 is activated.

A hub 20 is provided. The hub 20 can extend from the handle section 12 at any desired angle. The hub 20 is symmetrically disposed around an imaginary central axis 22. The hub 20 is attached to the drive shaft 19 of the motor 16 along that imaginary central axis 22. Consequently, when the motor 16 is activated, the hub 20 spins in a balanced manner.

A plurality of fiber optic bundles 24 extend from the face surface 25 of the hub 20. Each fiber optic bundle 24 is comprised of a plurality of fiber optic strands 26. The different fiber optic bundles 24 terminate in space in front of the face surface 25 of the hub 20. Although the fiber optic bundles 24 can all terminate at the same length, it is preferred that each of the fiber optic bundles 24 terminates at a different length. Furthermore, it is preferred that each of the fiber optic bundles 24 extends from the face surface 25 of the hub 20 at a position that is eccentric to the imaginary central axis 22 of the hub 20.

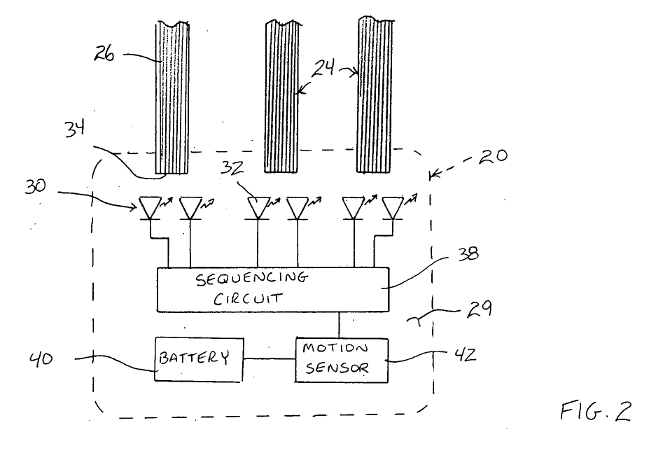

Referring to FIG. 2, it will be understood that the hub 20 defines an internal chamber 29. Within the internal chamber 29 is a matrix 30 of light emitting diodes 32. At least one light emitting diode 32 is disposed below each of the fiber optic bundles 24. Thus, any light emitted by the light emitting diodes 32 will be received by the first end 34 of the fiber optic bundles 24 that extends into the internal chamber 29 of the hub 20. That light will propagate through the individual fiber optic strands 26 in each fiber optic bundle 24 and will shine from the second free ends of the fiber optic strands 26.

The light emitting diodes 32 are coupled to a sequencing circuit 38. The sequencing circuit 38 causes the various light emitting diodes 32 to light at different times and in different combinations. For example, the matrix 30 of light emitting diodes 32 may contain individual light emitting diodes of different colors. The sequencing circuit 38 can cause light emitting diodes 32 of differing colors to light at different predetermined times and at predetermined positions in the matrix 30. Consequently, the light propagating through the various fiber optic bundles 24 can be engineered to conform to distinct color schemes and lighting patterns.

A battery 40 is supplied within the internal chamber 29 of the hub 20. A motion sensor 42 is also provided. The motion sensor 42 joins the battery 40 to the sequencing circuit 38 and the light emitting diodes 32. As a result, the battery 40 will not power the light emitting diodes 32 until the motion sensor 42 detects that the hub 20 is in motion. However, once the hub 20 is in motion, the light emitting diodes 32 will shine in the light patterns determined by the sequencing circuit 38.

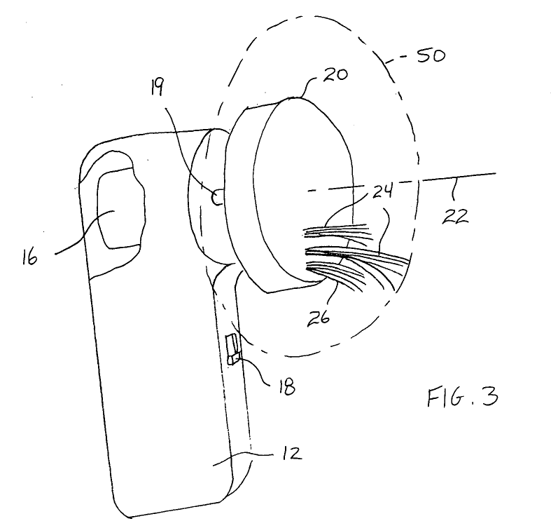

Referring to FIG. 3, it can be seen that when the on/off switch 18 on the handle section 12 is activated, the motor 16 within the handle section 12 spins. This causes the drive shaft 19 of the motor 16 to spin, which causes the hub 20 to spin. As the hub 20 spins, centrifugal forces cause the fiber optic strands 26 in the fiber optic bundles 24 to flare outwardly. The fiber optic strands 26 in the longer fiber optic bundles 24 will flare out farther than the shorter ones. Thus, when the hub 20 is spinning, the various fiber optic bundles 24 will flare out to different points around the imaginary central axis 22 of the spinning hub 20.

Simultaneously, as the fiber optic strands 26 are flaring outwardly, the motion sensor 42 (FIG. 2) detects the movement of the hub 20 and lights the light emitting diodes 32 (FIG. 2). The result is that circular patterns of light 50 are created, wherein the circular patterns of light 50 exist at different radii from the central point of rotation. The color of the circular pattern of lights 50 and the lighting patterns embodied by the circular pattern of lights 50 change to follow the color and pattern schemes produced by the sequencing circuit 38 within the hub 20.

As the fiber optic strands 26 flare outwardly from centrifugal force, the individual fiber optic strands 26 tend to slightly fan apart. As a consequence, should the fiber optic strands 26 ever contact an object while spinning, the mass of each fiber optic strand 26 is so small that it lightly brushes the surfaces it contacts. Contact with an external object also immediately slows the rotation of the hub 20, which causes the fiber optic strands 26 to retract back toward the hub 20 and out of harm's way. The result is a greatly reduced risk of injury caused by inadvertent contact.

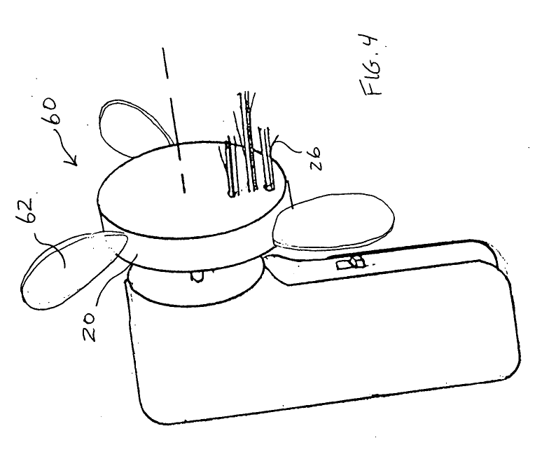

Referring to FIG. 4. an alternate embodiment of the present invention spinning illumination device 60 is shown. In this embodiment, soft foam fan paddles 62 are attached to the hub 20. As a result, when the hub 20 spins, not only do the fiber optic strands 26 flare and light, but the fan paddles 62 spin and a breeze is created. Otherwise the operation of the spinning illumination device 60 is the same as has been previously described.

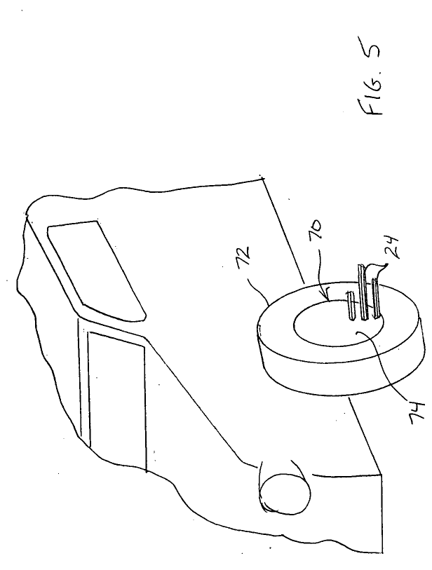

Referring to FIG. 5, yet another alternate embodiment of the present invention spinning illumination device 70 is shown. In this embodiment, the spinning illumination device 70 is disposed on the wheel 72 of a toy car. The wheel 72 of the toy car acts as a hub, wherein the fiber optic bundles 24 extend from the front surface 74 of the wheel 72. As the wheel 72 turns, the fiber optic bundles 24 flare and light in the manner previously described. The fiber optic bundles 24 on the wheel 72, however, are designed to flare beyond the periphery of the wheel 72 so that the fiber optic bundles 24 do not strike the ground and inhibit motion as the wheels 72 turn.

The embodiments of FIG. 4 and FIG. 5 are provided to show that the present invention spinning illumination device can be applied to any preexisting surface that spins, such as a fan or a toy car wheel. It will therefore be understood that the embodiments of the present invention that are illustrated and described are merely exemplary and that a person skilled in the art can make many variations using functionally equivalent components or applying the invention to other spinning items. All such variations, modifications and alternate embodiments are intended to be included within the scope of the present invention as claimed.

What is claimed is:

1. An illumination device, comprising:
a hub having an axis of rotation about which said hub can spin;
at least one light source supported by said hub; and
at least one fiber optic bundle that extends from said hub at a point eccentric to said axis of rotation, wherein said fiber optic bundle has a first end that receives light from said light source and a second end that terminates a predetermined distance from said hub.

2. The device according to claim 1, wherein said at least one fiber optic bundle is comprised of multiple fiber optic strands that hang freely at said second end.

3. The device according to claim 1, wherein multiple fiber optic bundles are supported by said hub.

4. The device according to claim 3, wherein each of said multiple fiber optic bundles is a different distance from said axis of rotation of said hub.

5. The device according to claim 3, wherein each of said multiple fiber optic bundles extends a different distance from said hub.

6. The device according to claim 1, wherein multiple light sources are supported by said hub.

7. The device according to claim 6, wherein said multiple light sources include light sources of different color.

8. The device according to claim 6, further including a sequencing circuit for lighting said multiple light sources in a predetermined sequence pattern.

9. The device according to claim 1, further including a motion sensor coupled to said at least one light source, wherein said motion sensor activates said at least one light source only when said motion sensor detects motion in said hub.

10. The device according to claim 1, further including a battery supported in said hub for providing power to said at least one light source.

11. The device according to claim 1, further including a motor for turning said hub around said axis of rotation.

12. A method of creating a spinning pattern of light, comprising the steps of:
providing a surface that can spin about an axis of rotation;
providing at least one bundle of fiber optics that extend outwardly from said surface eccentric from said axis of rotation;
propagating light through said at least one bundle of fiber optics;
spinning said surface about said axis of rotation causing said at least one bundle of fiber optics to bend away from said axis of rotation under centrifugal force.

13. The method according to claim 12, wherein said step of providing at least one bundle of fiber optics includes providing multiple fiber optic bundles that extend outwardly from said surface at points eccentric to said axis of rotation.

14. The method according to claim 13, wherein each of said multiple fiber optic bundles extends from said surface at a different distance from said axis of rotation.

15. The method according to claim 13, wherein each of said multiple fiber optic bundles extends a different distance from said surface.

16. The method according to claim 12, wherein said step of propagating light includes providing multiple light sources that shine light into said at least one bundle of fiber optics.

17. The method according to claim 16, further including the step of lighting said multiple light sources in a predetermined sequence pattern.

18. The method according to claim 16, further including the step of providing a motion sensor that activates said at least one light source only when said motion sensor detects said surface is in motion.

19. The method according to claim 12, further including the step of turning said surface around said axis of rotation.
